(19) United States
(12) Patent Application Publication
(10) Pub. No.: US 2022/0413513 A1
(43) Pub. Date: Dec. 29, 2022

(54) ROBOT MANAGEMENT SYSTEM, ROBOT MANAGEMENT METHOD, AND PROGRAM

(71) Applicant: TOYOTA JIDOSHA KABUSHIKI KAISHA, Toyota-shi (JP)

(72) Inventors: Shiro ODA, Anjo-shi (JP); Tetsuya Taira, Nagakute-shi (JP); Satoshi Toyoshima, Okazaki-shi (JP); Yuta Watanabe, Toyota-shi (JP); Takeshi Matsui, Nisshin-shi (JP); Takayoshi Nasu, Okazaki-shi (JP); Kei Yoshikawa, Nagoya-shi (JP); Yusuke Ota, Nagakute-shi (JP); Yutaro Ishida, Toyota-shi (JP); Yuji Onuma, Nagoya-shi (JP); Kyosuke Arai, Toyota-shi (JP)

(73) Assignee: TOYOTA JIDOSHA KABUSHIKI KAISHA, Toyota-shi (JP)

(21) Appl. No.: 17/738,581

(22) Filed: May 6, 2022

(30) Foreign Application Priority Data
Jun. 24, 2021 (JP) 2021-104967

(51) Int. Cl. G05D 1/02; G01G 19/08; B60C 11/24; G06Q 10/06; G06Q 10/00

(52) U.S. Cl. CPC G05D 1/0287; G05D 1/0217; G05D 1/0272; G01G 19/08; B60C 11/246; G06Q 10/06315; G06Q 10/20

(57) ABSTRACT

A robot management system executes, for a plurality of transport robots, an estimation process for estimating load applied to the transport robots based on a current value during traveling and a traveling distance or a traveling time of the transport robots. The robot management system determines a transport robot to be used from among the transport robots based on an estimation result in the estimation process.

### CROSS-REFERENCE TO RELATED APPLICATION

This application claims priority to Japanese Patent Application No. 2021-104967 filed on Jun. 24, 2021, incorporated herein by reference in its entirety.

### BACKGROUND

### 1. Technical Field

The present disclosure relates to a robot management system, a robot management method, and a program.

### 2. Description of Related Art

Japanese Patent No. 5807990 (JP 5807990 B) discloses a system for prioritizing a mobile robot to be used from among a plurality of mobile robots.

### SUMMARY

However, when operating a plurality of transport robots that transports transported objects, the task amount differs between the transport robots, and thus the degree of wear differs. Therefore, it is difficult to adjust the maintenance period of these transport robots. The system described in JP 5807990 B cannot address these problems.

The present disclosure has been made to solve such problems, and an object of the present disclosure is to provide a robot management system, a robot management method, and a program capable of operating a plurality of transport robots according to the degree of wear of the transport robots.

A robot management system according to a first aspect of the present disclosure executes, for a plurality of transport robots, an estimation process for estimating load applied to the transport robots based on a current value during traveling and a traveling distance or a traveling time of the transport robots, and determines a transport robot to be used from among the transport robots based on an estimation result in the estimation process. With such a configuration, in the above robot management system, when operating a plurality of transport robots, it is possible to perform operations according to the degree of wear of the transport robots.

In the above robot management system, the transport robots may include tires. The estimation process may include estimating a degree of wear of the tires by using a product of the current value and the traveling distance or the traveling time as the load or a part of the load. This makes it possible to perform operations according to the degree of tire wear of the transport robots.

In the above robot management system, the transport robot to be used may be determined such that an amount of the load is not biased among the transport robots. As a result, the plurality of transport robots can be operated so that the degree of wear is aligned. In the above robot management system, the transport robot to be used may be determined such that a timing at which the amount of the load exceeds a predetermined threshold value meets a predetermined schedule. As a result, the plurality of transport robots can be operated so that maintenance can be performed at the same period. Here, the predetermined schedule may be set at a period when there is a small amount of work in a facility where the transport robots perform transportation. As a result, the plurality of transport robots can be operated so that maintenance can be performed at a period when there is a small amount of work.

The estimation process may be executed using weight information indicating a weight of a loaded object that is loaded on the transport robots. This allows the load to be estimated to correspond to the weight of the loaded object. The estimation process may be executed by using route information indicating a route traveled by the transport robots. This allows the load to be estimated to correspond to the traveling route. In the above robot management system, the transport robot to be used may be determined based on at least one of scheduled route information indicating the route that is scheduled to be used for transportation and scheduled transported object information indicating a transported object that is scheduled to be transported. This makes it easier to adjust the load between the plurality of transport robots.

The estimation process may further include a process of estimating, for the transport robots, a maintenance timing of the transport robots. As a result, the transport robot to be used can be determined according to the maintenance timing of the transport robots, and the operation can be performed according to the need for maintenance of the transport robots.

A robot management method according to a second aspect of the present disclosure executes, for a plurality of transport robots, an estimation process for estimating load applied to the transport robots based on a current value during traveling and a traveling distance or a traveling time of the transport robots, and determines a transport robot to be used from among the transport robots based on an estimation result in the estimation process. With such a configuration, when operating a plurality of transport robots, it is possible to perform operations according to the degree of wear of the transport robots.

In the above robot management method, the transport robots may include tires. The estimation process may include estimating a degree of wear of the tires by using a product of the current value and the traveling distance or the traveling time as the load or a part of the load. This makes it possible to perform operations according to the degree of tire wear of the transport robots.

In the above robot management method, the transport robot to be used may be determined such that an amount of the load is not biased among the transport robots. As a result, the plurality of transport robots can be operated so that the degree of wear is aligned. In the above robot management method, the transport robot to be used may be determined such that a timing at which the amount of the load exceeds a predetermined threshold value meets a predetermined schedule. As a result, the plurality of transport robots can be operated so that maintenance can be performed at the same period. Here, the predetermined schedule may be set at a period when there is a small amount of work in a facility where the transport robots perform transportation. As a result, the plurality of transport robots can be operated so that maintenance can be performed at a period when there is a small amount of work.

The estimation process may be executed using weight information indicating a weight of a loaded object that is loaded on the transport robots. This allows the load to be estimated to correspond to the weight of the loaded object. The estimation process may be executed by using route information indicating a route traveled by the transport robots. This allows the load to be estimated to correspond to the traveling route. In the above robot management method, the transport robot to be used may be determined based on at least one of scheduled route information indicating the route that is scheduled to be used for transportation and scheduled transported object information indicating a transported object that is scheduled to be transported. This makes it easier to adjust the load between the plurality of transport robots.

The estimation process may further include a process of estimating, for the transport robots, a maintenance timing of the transport robots. As a result, the transport robot to be used can be determined according to the maintenance timing of the transport robots, and the operation can be performed according to the need for maintenance of the transport robots.

A program according to a third aspect of the present disclosure is a program for causing a computer to execute processes including executing, for a plurality of transport robots, an estimation process for estimating load applied to the transport robots based on a current value during traveling and a traveling distance or a traveling time of the transport robots, and determining a transport robot to be used from among the transport robots based on an estimation result in the estimation process. With such a configuration, when operating a plurality of transport robots, it is possible to perform operations according to the degree of wear of the transport robots.

In the above program, the transport robots may include tires. The estimation process may include estimating a degree of wear of the tires by using a product of the current value and the traveling distance or the traveling time as the load or a part of the load. This makes it possible to perform operations according to the degree of tire wear of the transport robots.

In the above program, the transport robot to be used may be determined such that an amount of the load is not biased among the transport robots. As a result, the plurality of transport robots can be operated so that the degree of wear is aligned. In the above program, the transport robot to be used may be determined such that a timing at which the amount of the load exceeds a predetermined threshold value meets a predetermined schedule. As a result, the plurality of transport robots can be operated so that maintenance can be performed at the same period. Here, the predetermined schedule may be set at a period when there is a small amount of work in a facility where the transport robots perform transportation. As a result, the plurality of transport robots can be operated so that maintenance can be performed at a period when there is a small amount of work.

The estimation process may be executed using weight information indicating a weight of a loaded object that is loaded on the transport robots. This allows the load to be estimated to correspond to the weight of the loaded object. The estimation process may be executed by using route information indicating a route traveled by the transport robots. This allows the load to be estimated to correspond to the traveling route. In the above program, the transport robot to be used may be determined based on at least one of scheduled route information indicating the route that is scheduled to be used for transportation and scheduled transported object information indicating a transported object that is scheduled to be transported. This makes it easier to adjust the load between the plurality of transport robots.

The estimation process may further include a process of estimating, for the transport robots, a maintenance timing of the transport robots. As a result, the transport robot to be used can be determined according to the maintenance timing of the transport robots, and the operation can be performed according to the need for maintenance of the transport robots.

The present disclosure can provide a robot management system, a robot management method, and a program capable of operating a plurality of transport robots according to the degree of wear of the transport robots.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an overall configuration example of a system in which a mobile robot according to the present embodiment is used;

FIG. 2 is a control block diagram showing an example of a control system of the system according to the present embodiment;

FIG. 3 is a schematic view showing an example of the mobile robot;

FIG. 4 is a schematic diagram showing a main configuration example of a drive unit of the mobile robot;

FIG. 5 is a diagram showing an example of a movement route of the mobile robot;

FIG. 6 is a diagram showing an example of a table in which a current value, a traveling distance, and a traveling time for each mobile robot are stored;

FIG. 7 is a diagram showing an example of a load estimation result for each mobile robot;

FIG. 8 is a diagram showing an example of an estimation result of the maintenance timing for each mobile robot;

FIG. 9 is a flowchart showing an example of a robot management method according to the present embodiment; and

FIG. 10 is a flowchart showing another example of a robot management method according to the present embodiment.

### DETAILED DESCRIPTION OF EMBODIMENTS

Hereinafter, the present disclosure will be described through embodiments of the disclosure. However, the disclosure according to the claims is not limited to the following embodiments. Moreover, all of the configurations described in the embodiments are not necessarily indispensable as means for solving the issue.

Schematic Configuration

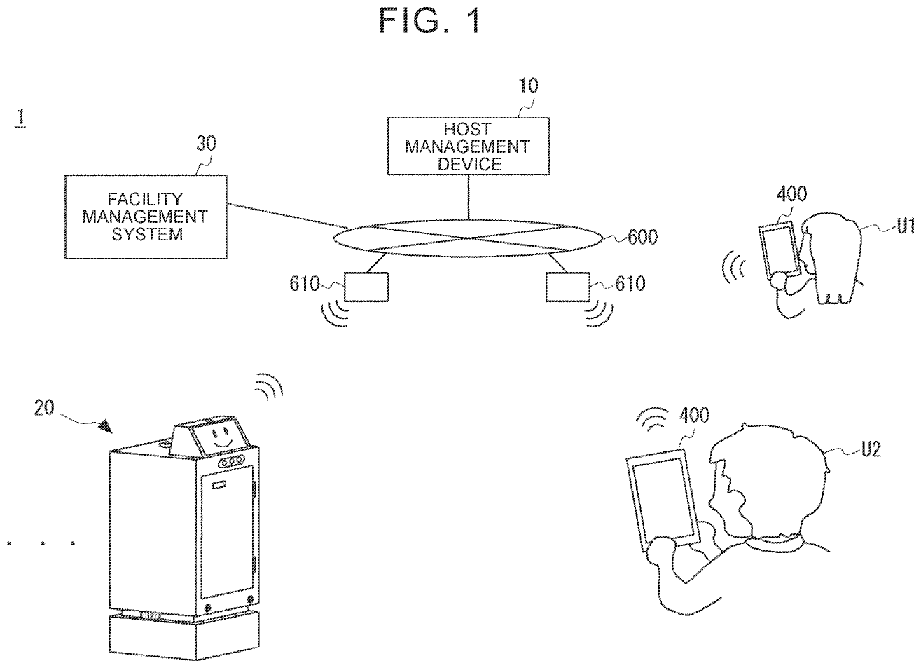

FIG. 1 is a conceptual diagram illustrating an overall configuration example of a system 1 in which a mobile robot 20 according to the present embodiment is used. The system 1 according to the present embodiment is a system for transporting a transported object by using a plurality of mobile robots that can autonomously move in a facility, and can be referred to a robot management system for managing the mobile robots.

As the mobile robot applicable in the present embodiment, the mobile robot 20 as shown in FIG. 1 will be described here as an example, but the shape and components thereof are not limited. For example, the mobile robot is not limited to one having wheels, but may be a flying object (flying robot) such as a drone, and traveling in that case means flying. Although the description is based on the premise that each mobile robot 20 transports one or a plurality of transported objects independently, a plurality of mobile robots 20 may cooperate to transport one or a plurality of transported objects.

The mobile robot 20 is a transport robot that executes transportation of a transported object as a task. The mobile robot 20 autonomously travels in order to transport a transported object in a medical welfare facility such as a hospital, a rehabilitation center, a nursing facility, and an elderly care facility. The system 1 according to the present embodiment can also be used in a facility (inside a building) such as a commercial facility such as a shopping mall, a hotel, a restaurant, an office building, or an event venue. It goes without saying that the mobile robot 20 may be able to move autonomously not only inside the facility but also outside the facility.

A user U1 or a user U2 stores the transported object in the mobile robot 20 and requests the transportation. The mobile robot 20 autonomously moves to the set destination to transport the transported object. That is, the mobile robot 20 executes a luggage transport task (hereinafter also simply referred to as a task). In the following description, the location where the transported object is loaded is referred to as a transport source, and the location where the transported object is delivered is referred to as a transport destination. The user U1 or the user U2 may load the transported object on the mobile robot of another example (not shown) with the transported object exposed to transport the transported object. However, for simplifying the description, it is assumed that the transported object is transported with the transported object stored in the mobile robot 20.

For example, it is assumed that the mobile robot 20 moves in a general hospital having a plurality of clinical departments. The mobile robot 20 transports equipment, consumables, medical equipment, and the like between the clinical departments. For example, the mobile robot 20 delivers the transported object from a nurse station of one clinical department to a nurse station of another clinical department. Alternatively, the mobile robot 20 delivers the transported object from the storage of the equipment and the medical equipment to the nurse station of the clinical department. The mobile robot 20 also delivers medicine dispensed in the dispensing department to the clinical department or a patient that is scheduled to use the medicine.

Examples of the transported object include medicines, consumables such as bandages, specimens, testing instruments, medical equipment, hospital food, and equipment such as stationery. The medical equipment includes sphygmomanometers, blood transfusion pumps, syringe pumps, foot pumps, nurse call buttons, bed leaving sensors, low-pressure continuous inhalers, electrocardiogram monitors, drug injection controllers, enteral nutrition pumps, artificial respirators, cuff pressure gauges, touch sensors, aspirators, nebulizers, pulse oximeters, artificial resuscitators, aseptic devices, echo machines, and the like. Meals such as hospital food and inspection meals may also be transported. Further, the mobile robot 20 may transport used equipment, tableware that have been used during meals, and the like. When the transport destination is on a different floor, the mobile robot 20 may move using an elevator or the like.

In addition to the mobile robot 20, the system 1 includes a host management device 10, a facility management system 30, a network 600, a communication unit 610, and a user terminal 400. The user U1 or the user U2 can make a transport request for the transported object using the user terminal 400. For example, the user terminal 400 is a tablet computer, a smartphone, or the like, and may be a stationary computer. The user terminal 400 only needs to be an information processing device capable of wireless or wired communication.

When the transported object is a lending equipment such as the medical equipment, the user U1 or the user U2 can request the transportation of the lending equipment according to the schedule for lending (lending schedule). This lending schedule can be managed by an equipment lending system (not shown) connected to the network 600, can be referred to by the user U1 or the user U2 for a transport request from the user terminal 400, and can also be referred to by the host management device 10.

In the present embodiment, as shown in FIG. 1, the facility management system 30, the mobile robot 20, and the user terminal 400 are connected to the host management device 10 via the network 600. The mobile robot 20 and the user terminal 400 are connected to the network 600 via the communication unit 610. The network 600 is a wired or wireless local area network (LAN) or wide area network (WAN). The host management device 10 is connected to the network 600 by wire or wirelessly. The communication unit 610 is, for example, a wireless LAN unit installed in each environment. The communication unit 610 may be a general-purpose communication device such as a WiFi (registered trademark, the same applies hereinafter) router.

The host management device 10 is a server connected to each equipment, and collects data from each equipment. The host management device 10 is not limited to a physically single device, and may have a plurality of devices that performs distributed processing. Further, the host management device 10 may be distributedly provided in edge devices such as the mobile robot 20. For example, a part or all of the system 1 may be installed in the mobile robot 20.

Various signals transmitted from the user terminals 400 of the users U1 and U2 are once sent to the host management device 10 via the network 600, and transmitted from the host management device 10 to the target mobile robots 20. Similarly, various signals transmitted from the mobile robot 20 are once sent to the host management device 10 via the network 600, and transmitted from the host management device 10 to the target user terminal 400.

The user terminal 400 and the mobile robot 20 may transmit and receive signals without the host management device 10. For example, the user terminal 400 and the mobile robot 20 may directly transmit and receive signals by wireless communication. Alternatively, the user terminal 400 and the mobile robot 20 may transmit and receive signals via the communication unit 610.

The user U1 or the user U2 requests the transportation of the transported object using the user terminal 400. Hereinafter, description is made assuming that the user U1 is the transport requester at the transport source and the user U2 is the planned recipient at the transport destination (destination). Needless to say, the user U2 at the transport destination can also make a transport request. Further, a user who is located at a location other than the transport source or the transport destination may make a transport request.

When the user U1 makes a transport request, the user U1 inputs, using the user terminal 400, the content of the transported object, the receiving point of the transported object (hereinafter also referred to as the transport source), the delivery destination of the transported object (hereinafter also referred to as the transport destination), the estimated arrival time at the transport source (the receiving time of the transported object), the estimated arrival time at the transport destination (the transport deadline), and the like. Hereinafter, these types of information are also referred to as transport request information. The user U1 can input the transport request information by operating the touch panel of the user terminal 400. The transport source may be a location where the user U1 is present, a storage location for the transported object, or the like. The transport destination is a location where the user U2 or a patient who is scheduled to use the transported object is present.

The user terminal 400 transmits the transport request information input by the user U1 to the host management device 10. The host management device 10 is a management system that manages a plurality of mobile robots 20, and constitutes the robot management system itself or a main part thereof according to the present embodiment. The host management device 10 transmits an operation command for executing a transport task to the mobile robot 20. The host management device 10 determines the mobile robot 20 that executes the transport task, that is, the mobile robot 20 to be used, for each transport request. This determination method is one of the main features of the present embodiment, and will be described later. The host management device 10 transmits a control signal including an operation command to the mobile robot 20. The mobile robot 20 moves from the transport source so as to arrive at the transport destination in accordance with the operation command.

For example, the host management device 10 can assign a transport task to the mobile robot 20 at or near the transport source. Alternatively, the host management device 10 can assign a transport task to the mobile robot 20 heading toward the transport source or its vicinity. Such a method can be used as one reference for the assignment of the transport task, but basically, as described later as a feature of the present embodiment, the assignment of the transport task is performed by estimating the load applied to each mobile robot 20 up to now and determining the mobile robot 20 to which the transport task is assigned based on the estimation result. The mobile robot 20 to which the task is assigned goes to the transport source to pick up the transported object. The transport source is, for example, a location where the user U1 who has requested the task is present.

When the mobile robot 20 arrives at the transport source, the user U1 or another staff member loads the transported object on the mobile robot 20. The mobile robot 20 on which the transported object is loaded autonomously moves with the transport destination set as the destination. The host management device 10 transmits a signal to the user terminal 400 of the user U2 at the transport destination. Thus, the user U2 can recognize that the transported object is being transported and the estimated arrival time. When the mobile robot 20 arrives at the set transport destination, the user U2 can receive the transported object stored in the mobile robot 20. In this way, the mobile robot 20 executes the transport task.

In the overall configuration described above, each element of the control system can be distributed to the mobile robot 20, the user terminal 400, and the host management device 10 (and the facility management system 30) to construct the control system as a whole. Further, it is possible to collect substantial elements for achieving the transportation of the transported object in a single device to construct the system. The host management device 10 controls one or more mobile robots 20.

In this way, various signals transmitted from the user terminals 400 of the users U1 and U2 can be once sent to the host management device 10 via the network 600, and transmitted from the host management device 10 to the target mobile robots 20. Similarly, various signals transmitted from the mobile robot 20 are once sent to the host management device 10 via the network 600, and transmitted from the host management device 10 to the target user terminal 400.

The facility management system 30 is a system that manages the facility. The facility management system 30 can manage the schedule of work in the facility and can include or be connected to the above-mentioned equipment lending system. Further, the facility management system 30 can manage lighting equipment, air conditioning equipment, and the like in each area of the facility, for example.

A part of the functions of the facility management system 30 may be distributedly provided in the host management device 10, or may be incorporated in the host management device 10. A part of the functions of the facility management system 30 may be distributedly provided in edge devices such as the mobile robot 20.

Control Block Diagram

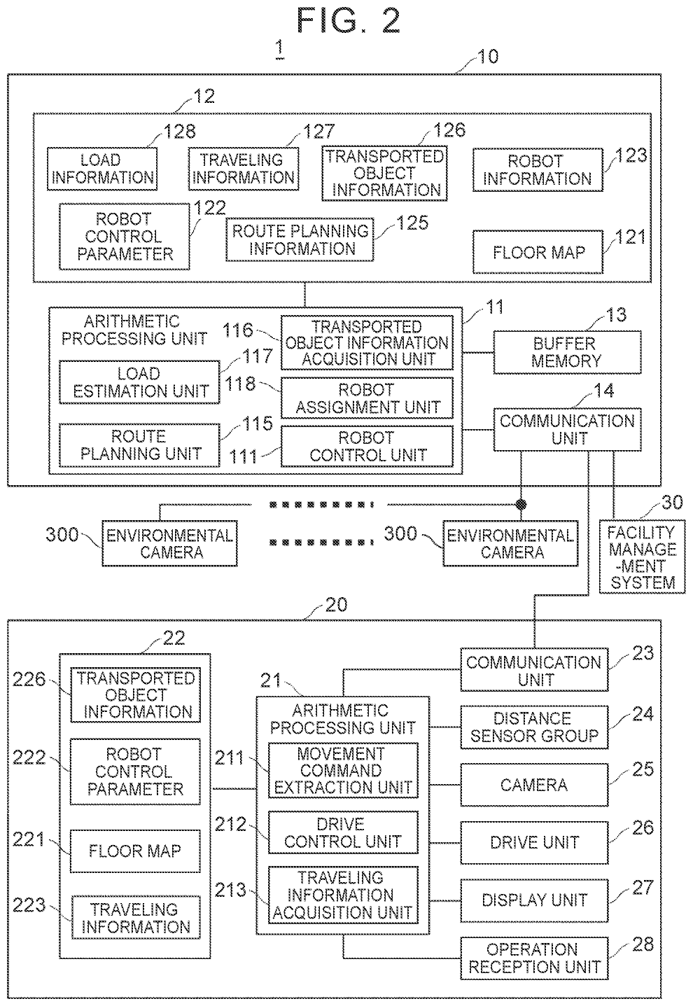

FIG. 2 is a control block diagram showing an example of the control system of the system 1. As shown in FIG. 2, the system 1 can include the host management device 10, the mobile robot 20, the facility management system 30, and environmental cameras 300.

The system 1 efficiently controls a plurality of mobile robots 20 while causing the mobile robots 20 to autonomously move in a predetermined facility. Therefore, a plurality of environmental cameras 300 is installed in the facility. For example, the environmental cameras 300 are each installed in a passage, a hallway, an elevator, an entrance/exit, a vicinity of a security gate, etc. in the facility.

The environmental cameras 300 acquire images of ranges in which the mobile robot 20 moves. In the system 1, the host management device 10 collects the images acquired by the environmental cameras 300 and the information based on the images. Alternatively, the images or the like acquired by the environmental cameras 300 may be directly transmitted to the mobile robots. The environmental cameras 300 may be surveillance cameras or the like provided in a passage or an entrance/exit in the facility. The environmental cameras 300 may be used to determine the distribution of congestion status in the facility.

Here, an example in which the environmental cameras 300 are directly connected to the host management device 10 is given. However, it is also possible to adopt a configuration in which the environmental cameras 300 are management targets of the facility management system 30, and the host management device 10 receives data obtained by the environmental cameras 300 via the facility management system 30.

In the system 1, the host management device 10 performs route planning based on the transport request information and generates route planning information (route planning information 125 described later). The route planning information can be generated as information for planning a transport route corresponding to the above-described lending schedule, for example. The host management device 10 instructs a destination for each mobile robot 20 based on the generated route planning information. Then, the mobile robot 20 autonomously moves toward the destination designated by the host management device 10. The mobile robot 20 autonomously moves toward the destination using sensors, floor maps, position information, and the like provided in the mobile robot 20 itself.

For example, the mobile robot 20 travels so as not to come into contact with surrounding equipment, objects, walls, and people (hereinafter collectively referred to as peripheral objects). Specifically, the mobile robot 20 detects the distance from the peripheral object and travels while keeping a distance from the peripheral object by a certain distance (defined as a distance threshold value) or more. When the distance from the peripheral object becomes equal to or less than the distance threshold value, the mobile robot 20 decelerates or stops. In this way, the mobile robot 20 can travel without coming into contact with the peripheral objects. Since contact can be avoided, safe and efficient transportation is possible. The threshold distance is a predetermined distance set so that each mobile robot can travel safely.

First, the host management device 10 in FIG. 2 will be described. The host management device 10 can include an arithmetic processing unit 11, a storage unit 12, a buffer memory 13, and a communication unit 14. The arithmetic processing unit 11 performs arithmetic for controlling and managing the mobile robot 20. The arithmetic processing unit 11 can be implemented as a device capable of executing a program such as a central processing unit (CPU) of a computer, for example. Various functions can also be realized by a program. Only a robot control unit 111, a route planning unit 115, a transported object information acquisition unit 116, a load estimation unit 117, and a robot assignment unit 118 that are characteristics of the arithmetic processing unit 11 are shown in FIG. 2, but other processing blocks can also be provided.

The robot control unit 111 performs arithmetic for remotely controlling the mobile robot 20 and generates a control signal. The robot control unit 111 generates a control signal based on the route planning information 125 and the like, which will be described later. Further, the robot control unit 111 generates a control signal based on various types of information obtained from the environmental cameras 300 and the mobile robots 20. The control signal may include update information such as a floor map 121, robot information 123, and a robot control parameter 122, which will be described later. That is, when various types of information are updated, the robot control unit 111 generates a control signal in accordance with the updated information.

The transported object information acquisition unit 116 acquires information on the transported object. The transported object information acquisition unit 116 acquires information on the content (type) of the transported object that is being transported by the mobile robot 20, and stores the information as transported object information 126 in the storage unit 12. When the transported object is a lending equipment, the transported object information 126 can be obtained from the above-mentioned lending schedule. The transported object information 126 can include weight information indicating the weight of each transported object or the total weight of all the transported objects to be transported.

The route planning unit 115 performs route planning for each mobile robot 20. When the transport task is input, the route planning unit 115 performs route planning for transporting the lending equipment to the transport destination (destination) based on the transport request information. Specifically, the route planning unit 115 refers to the route planning information 125, the robot information 123, and the like already stored in the storage unit 12 to determine a candidate of the mobile robot 20 that can execute a new transport task from the mobile robots 20 that are the management targets, and updates the route planning information 125 to add the route plan for the new transport task. However, it is also possible to adopt a configuration in which no candidate is selected for the new transport task. The starting point is the current position of the mobile robot 20, the transport destination of the immediately preceding transport task, the receiving point, or the like. The destination is the transport destination of the transported object, but may be a standby location, a charging location, or the like.

Here, the route planning unit 115 sets passing points from the starting point to the destination of the mobile robot 20. The route planning unit 115 sets the passing order of the passing points for each mobile robot 20, but here, it is sufficient to set only the mobile robot 20 that has been selected as a candidate. The passing points are set, for example, at branch points, intersections, lobbies in front of elevators, and their surroundings. In a narrow passage, it may be difficult for the mobile robots 20 to pass each other. In such a case, the passing point may be set at a location before the narrow passage. Candidates for the passing points may be registered in the floor map 121 in advance.

The robot assignment unit 118 determines the mobile robot 20 to be used for transportation from the mobile robots 20 that have been selected as candidates here, and updates the route planning information 125. This determination is based on the estimation result of the load estimation unit 117 described later, and as a result, the operation according to the degree of wear of the mobile robots 20, that is, the operation considering maintenance can be performed. However, the robot assignment unit 118 can also determine the mobile robot 20 to be used by adding the condition to preferentially assign the transport task to the mobile robot 20 at standby or the mobile robot 20 located near the transport source. In this case, the robot assignment unit 118 can determine the mobile robot 20 to be used from the mobile robots 20 selected as candidates in the route planning unit 115 by further adding a condition. Alternatively, the robot assignment unit 118 can determine the mobile robot 20 to be used from the management targets without the process of selecting the candidates by the route planning unit 115.

The route planning unit 115 sets the passing points including a starting point and a destination for the candidate mobile robot 20 to which the transport task is assigned or for the mobile robot 20 that has been determined to be used by the robot assignment unit 118. For example, when there are two or more movement routes from the transport source to the transport destination, the passing points are set such that the movement can be performed in a shorter time. Thus, the host management device 10 updates the information indicating the congestion status of the passages based on the images of the camera or the like. Specifically, locations where other mobile robots 20 are passing and locations with many people have a high degree of congestion. In this way, the route planning unit 115 can set the passing points so as to avoid locations with a high degree of congestion.

The mobile robot 20 may be able to move to the destination by either a counterclockwise movement route or a clockwise movement route. In such a case, the route planning unit 115 sets the passing points so as to pass through the less congested movement route. The route planning unit 115 sets one or more passing points to the destination, whereby the mobile robot 20 can move along a movement route that is not congested. For example, when a passage is divided at a branch point or an intersection, the route planning unit 115 sets a passing point at the branch point, the intersection, the corner, and the surroundings as appropriate. Thereby, the transport efficiency can be improved.

The route planning unit 115 may set the passing points in consideration of the congestion status of the elevator, the moving distance, and the like. Further, the host management device 10 may estimate the number of the mobile robots 20 and the number of people at the estimated time when the mobile robot 20 passes through a certain location. Then, the route planning unit 115 may set the passing points in accordance with the estimated congestion status. Further, the route planning unit 115 may dynamically change the passing points in accordance with a change in the congestion status. The route planning unit 115 sets the passing points in order for the candidate mobile robot 20 to which the transport task is assigned or for the mobile robot 20 to which the transport task is actually assigned. The passing points may include the transport source and the transport destination. The mobile robot 20 autonomously moves so as to sequentially pass through the passing points set by the route planning unit 115.

The storage unit 12 is a storage unit that stores information necessary for managing and controlling the robot. In the example of FIG. 2, the floor map 121, the robot information 123, the robot control parameter 122, the route planning information 125, the transported object information 126, traveling information 127, and load information 128 are shown, but the information stored in the storage unit 12 may include other information such as transmission history. The arithmetic processing unit 11 performs arithmetic using the information stored in the storage unit 12 when performing various processing. Various types of information stored in the storage unit 12 can be updated to the latest information.

The floor map 121 is map information of a facility in which the mobile robot 20 moves. The floor map 121 may be created in advance, may be generated from information obtained from the mobile robot 20, or may be information obtained by adding map correction information that is generated from information obtained from the mobile robot 20, to a basic map created in advance.

The robot information 123 indicates the ID, model number, specifications, and the like of the mobile robot 20 managed by the host management device 10. The robot information 123 may include position information indicating the current position of the mobile robot 20. The robot information 123 may include information on whether the mobile robot 20 is executing a task or at standby. The robot information 123 may also include information indicating whether the mobile robot 20 is operating, under repair, or the like. Further, the robot information 123 may include information on the transported object that can be transported and the transported object that cannot be transported. The robot information 123 may include information on the plane size, that is, information on the occupied area of the mobile robot 20.

The robot information 123 can be stored in association with the traveling information 127 and the load information 128, which will be described later, but can also include at least one of the traveling information 127 and the load information 128.

The robot control parameter 122 indicates control parameters such as a threshold distance from a peripheral object for the mobile robot 20 managed by the host management device 10. The threshold distance is a margin distance for avoiding contact with the peripheral objects including a person. Further, the robot control parameter 122 may include information on the operating intensity such as the speed upper limit value of the moving speed of the mobile robot 20.

In the robot control parameter 122, a plurality of threshold distances and speed upper limit values may be set. In this case, the host management device 10 may appropriately change the threshold distance and the speed upper limit value. For example, the threshold distance and the speed upper limit value may be set stepwise. The threshold distance and the speed upper limit value that are set stepwise may be associated with each other. For example, in the high-speed mode where the speed upper limit value is high, it is difficult to stop suddenly or decelerate, so the threshold distance is increased. In the low speed mode where the speed upper limit value is low, it is easy to stop suddenly or decelerate, so the threshold distance is reduced. In this way, the threshold distance may be changed in accordance with the speed upper limit value. The arithmetic processing unit 11 may change the speed upper limit value or the like in accordance with the transported object information or environment information. The host management device 10 selects the speed upper limit value and the threshold distance from the robot control parameter in accordance with the environment and the situation. When the speed upper limit value and the threshold distance are updated, the host management device 10 transmits the updated data to the mobile robot 20.

The robot control parameter 122 may be updated depending on the situation. The robot control parameter 122 may include information indicating the availability and usage status of the storage space of a storage 291 described later. The robot control parameter 122 may include information on a transported object that can be transported and a transported object that cannot be transported. The above-described various types of information in the robot control parameter 122 are associated with each mobile robot 20.

The route planning information 125 includes the route planning information planned by the route planning unit 115. The route planning information 125 includes, for example, information indicating a transport task. The route planning information 125 may include the ID of the mobile robot 20 to which the task is assigned, the starting point, the content of the transported object, the transport destination, the transport source, the estimated arrival time at the transport destination, the estimated arrival time at the transport source, the arrival deadline, and the like. The route planning information 125 can include information indicating whether the mobile robot 20 is a candidate for assignment of the task or is actually assigned with the task. In the route planning information 125, the various types of information described above may be associated with each transport task. The route planning information 125 may include at least a part of the transport request information input from the user U1.

Further, the route planning information 125 may include information on the passing points for each mobile robot 20 and each transport task. For example, the route planning information 125 includes information indicating the passing order of the passing points for each mobile robot 20. The route planning information 125 may include the coordinates of each passing point on the floor map 121 and information on whether the mobile robot 20 has passed the passing points.

The transported object information 126 is information on the transported object for which the transport request has been made. For example, the transported object information 126 includes information such as the content (type) of the transported object, the transport source, and the transport destination. The transported object information 126 may include the ID of the mobile robot 20 in charge of the transportation. Further, the transported object information 126 may include information indicating the status such as transport under way, pre-transport (before loading), and post-transport. These types of information in the transported object information 126 are associated with each transported object.

The route planning unit 115 refers to various types of information stored in the storage unit 12 to formulate a route plan. For example, the route planning unit 115 determines the mobile robot 20 that executes the task, based on the floor map 121, the robot information 123, the robot control parameter 122, and the route planning information 125. Then, the route planning unit 115 refers to the floor map 121 and the like to set the passing points to the transport destination and the passing order thereof. Candidates for the passing points are registered in the floor map 121 in advance. The route planning unit 115 sets the passing points in accordance with the congestion status and the like. In the case of continuous processing of tasks, the route planning unit 115 may set the transport source and the transport destination as the passing points.

Two or more mobile robots 20 may be assigned as a candidate or as a determined mobile robot 20 to one transport task. For example, when the transported object is larger than the transportable capacity of the mobile robot 20, one transported object is divided into two and loaded on the two mobile robots 20. Alternatively, when the transported object is heavier than the transportable weight of the mobile robot 20, one transported object is divided into two and loaded on the two mobile robots 20. In this way, one transport task can be shared and executed by two or more mobile robots 20. It goes without saying that, when the mobile robots 20 of different sizes are controlled, route planning may be performed such that the mobile robot 20 capable of transporting the transported object receives the transported object.

Further, one mobile robot 20 may perform two or more transport tasks in parallel. For example, one mobile robot 20 may simultaneously load two or more transported objects and sequentially transport the transported objects to different transport destinations. Alternatively, while one mobile robot 20 is transporting one transported object, another transported object may be loaded on the mobile robot 20. The transport destinations of the transported objects loaded at different locations may be the same or different. With this configuration, the tasks can be executed efficiently.

In such a case, storage information indicating the usage status or the availability of the storage space of the mobile robot 20 may be updated. That is, the host management device 10 may manage the storage information indicating the availability and control the mobile robot 20. For example, the storage information is updated when the transported object is loaded or received. When the transport task is input, the host management device 10 refers to the storage information and directs the mobile robot 20 having room for loading the transported object to receive the transported object. With this configuration, one mobile robot 20 can execute a plurality of transport tasks at the same time, and two or more mobile robots 20 can share and execute the transport tasks. For example, a sensor may be installed in the storage space of the mobile robot 20 to detect the availability. Further, the capacity and weight of each transported object may be registered in advance.

The traveling information 127 is information on traveling that is received and updated from each mobile robot 20 via the communication unit 14 periodically, every time the transport task is completed, or upon request from the host management device 10. The traveling information 127 includes the current value and the traveling distance or the traveling time during traveling in the target mobile robot 20, but can also include other information.

The load information 128 is information indicating the current load for each mobile robot 20 estimated by the load estimation unit 117 described below.

The load estimation unit 117 can be one of the main features of the present embodiment. For the plurality of mobile robots 20, the load estimation unit 117 executes an estimation process for estimating the load applied to each mobile robot 20 (that is, the degree of wear of the mobile robot 20) based on the current value (load due to the loaded object) during traveling and the traveling distance or the traveling time of the mobile robot 20. The algorithm of this estimation process is not limited, and the load estimation unit 117 can be configured to execute this estimation process by using a learning model trained by machine learning.

Then, the robot assignment unit 118 determines the mobile robot 20 to be used from the plurality of mobile robots 20 (in this example, from one or a plurality of mobile robots 20 determined as candidates for executing the target transport task in the route planning unit 115), based on the estimation result in the estimation process. However, as described above, the route planning unit 115 can determine only the route without selecting the candidates, and in that case, the robot assignment unit 118 may determine the mobile robot 20 to be used for a new transport task from all the mobile robots 20 that are the management targets.

With such a configuration, in the present embodiment, when operating a plurality of mobile robots 20, it is possible to perform operations according to the degree of wear of the mobile robots 20. For example, even when the mobile robot 20 closest to the calling point is a candidate to be called, when the degree of wear is high, another mobile robot 20 having a low degree of wear can be called and used. Therefore, the degree of wear can be equalized among the mobile robots 20 (transport task assignments can be equalized), or the degree of wear can be increased or decreased as compared with other mobile robots 20 in order to adjust the maintenance date. This has the effect of facilitating maintenance scheduling.

The buffer memory 13 is a memory that stores intermediate information generated in the processing of the arithmetic processing unit 11. The communication unit 14 is a communication interface for communicating with the facility management system 30, the plurality of environmental cameras 300 provided in the facility where the system 1 is used, and at least one mobile robot 20. The communication unit 14 can perform both wired communication and wireless communication. For example, the communication unit 14 transmits a control signal necessary for controlling each mobile robot 20 to each mobile robot 20. The communication unit 14 receives the information collected by the mobile robot 20 and the environmental cameras 300. The communication unit 14 may be able to receive various types of information such as facility operations from the facility management system 30, and may be able to transmit a request for such information to the facility management system 30.

Next, the mobile robot 20 in FIG. 2 will be described. The mobile robot 20 can include an arithmetic processing unit 21, a storage unit 22, a communication unit 23, a proximity sensor (for example, a distance sensor group 24), a camera 25, a drive unit 26, a display unit 27, and an operation reception unit 28. Although FIG. 2 shows only typical processing blocks provided in the mobile robot 20, the mobile robot 20 also includes many other processing blocks that are not shown.

The communication unit 23 is a communication interface for communicating with the communication unit 14 of the host management device 10. The communication unit 23 communicates with the communication unit 14 using, for example, a wireless signal. The distance sensor group 24 is, for example, a proximity sensor, and outputs proximity object distance information indicating a distance from an object or a person that is present around the mobile robot 20. The camera 25, for example, captures an image for grasping the surrounding situation of the mobile robot 20. The camera 25 can also capture an image of a position marker provided on the ceiling or the like of the facility, for example. The mobile robot 20 may be made to grasp the position of the mobile robot 20 itself using this position marker.

The drive unit 26 drives drive wheels provided on the mobile robot 20. The drive unit 26 may include an encoder or the like that detects the number of rotations of the drive wheels and the drive motor thereof. Further, the position of the mobile robot 20 (current position) may be estimated based on the output of the above encoder. The mobile robot 20 detects its current position and transmits the information to the host management device 10.

The display unit 27 and the operation reception unit 28 are realized by a touch panel display. The display unit 27 displays a user interface screen that serves as the operation reception unit 28. Further, the display unit 27 may display information indicating the destination of the mobile robot 20 and the state of the mobile robot 20. The operation reception unit 28 receives an operation from the user. The operation reception unit 28 includes various switches provided on the mobile robot 20 in addition to the user interface screen displayed on the display unit 27.

The arithmetic processing unit 21 performs arithmetic used for controlling the mobile robot 20. The arithmetic processing unit 21 can be implemented as a device capable of executing a program such as a CPU of a computer, for example. Various functions can also be realized by a program. The arithmetic processing unit 21 includes a movement command extraction unit 211, a drive control unit 212, and a traveling information acquisition unit 213. Although FIG. 2 shows only typical processing blocks included in the arithmetic processing unit 21, the arithmetic processing unit 21 includes processing blocks that are not shown. The arithmetic processing unit 21 may search for a route between the passing points.

The movement command extraction unit 211 extracts a movement command from the control signal given by the host management device 10. For example, the movement command includes information on the next passing point. For example, the control signal may include information on the coordinates of the passing points and the passing order of the passing points. The movement command extraction unit 211 extracts these types of information as a movement command.

Further, the movement command may include information indicating that the movement to the next passing point has become possible. When the passage width is narrow, the mobile robots 20 may not be able to pass each other. There are also cases where the passage cannot be used temporarily. In such a case, the control signal includes a command to stop the mobile robot 20 at a passing point before the location at which the mobile robot 20 should stop. After the other mobile robot 20 has passed or after movement in the passage has become possible, the host management device 10 outputs a control signal informing the mobile robot 20 that the mobile robot 20 can move in the passage. Thus, the mobile robot 20 that has been temporarily stopped resumes movement.

The drive control unit 212 controls the drive unit 26 such that the drive unit 26 moves the mobile robot 20 based on the movement command given from the movement command extraction unit 211. For example, the drive unit 26 includes drive wheels that rotate in accordance with a control command value from the drive control unit 212. The movement command extraction unit 211 extracts the movement command such that the mobile robot 20 moves toward the passing point received from the host management device 10. The drive unit 26 rotationally drives the drive wheels. The mobile robot 20 autonomously moves toward the next passing point. With this configuration, the mobile robot 20 sequentially passes the passing points so as to arrive at the transport destination. Further, the mobile robot 20 may estimate its position and transmit a signal indicating that the mobile robot 20 has passed the passing point to the host management device 10. Thus, the host management device 10 can manage the current position and the transport status of each mobile robot 20.

The traveling information acquisition unit 213 acquires a current value used by the drive unit 26 when the target transport task is executed and the traveling distance or the traveling time, or a current value used by the entire mobile robot 20 when the target transport task is executed and the traveling distance or the traveling time. The current value used by the drive unit 26 can be obtained from the above encoder or the like. Further, for example, the information obtained in the drive control by the drive control unit 212 can be acquired as the information of the current value and the traveling time or the traveling distance. The current value, the traveling time, and the traveling distance according to the control signal can also be determined based on a predetermined relationship. The time can be obtained by referring to a timer or the like provided in the arithmetic processing unit 21 or the like. The traveling distance can be obtained from, for example, the number of rotations of the encoder or the number of rotations obtained by a wheel sensor described later and the outer diameter of drive wheels 261.

The traveling information acquisition unit 213 records the acquired information as traveling information 223 of the storage unit 22. When the traveling information 223 already exists, the acquired information may be added. It is preferable to reset the traveling information 223 at a timing when the target part is maintained, or to store the traveling information 223 so that the maintenance date and time can be recognized. The information such as the current value may be information only for the drive unit 26 or information for the entire mobile robot 20 as described above, and further may be information for the drive unit 26 and other specific parts. It is sufficient to decide in advance which one of the above to adopt. Further, the current value can actually be another value related to the current used, such as an electric power value.

The storage unit 22 stores a floor map 221, a robot control parameter 222, the traveling information 223, and transported object information 226. FIG. 2 shows only a part of the information stored in the storage unit 22, and the storage unit 22 also includes information other than the information shown in FIG. 2. The floor map 221 is map information of a facility in which the mobile robot 20 moves. This floor map 221 is, for example, a download of the floor map 121 of the host management device 10. The floor map 221 may be created in advance. Further, the floor map 221 may not be the map information of the entire facility but may be the map information including a part of the area in which the mobile robot 20 is scheduled to move.

The robot control parameter 222 is a parameter for operating the mobile robot 20. The robot control parameter 222 includes, for example, a threshold distance from a peripheral object. Further, the robot control parameter 222 also includes a speed upper limit value of the mobile robot 20. When the mobile robot 20 receives the robot control parameter 122 updated in the host management device 10, the data of the robot control parameter 222 is updated.

Control may be performed so that the threshold distance changes stepwise in accordance with the moving speed while the mobile robot is moving. For example, when the mobile robot 20 accelerates and starts moving at high speed, the threshold distance is increased. That is, when the speed of the mobile robot 20 exceeds the speed threshold value, the threshold distance is increased. When the mobile robot 20 is moving at high speed, the braking distance increases, so it is preferable to increase the threshold distance, which is a margin distance. Therefore, the threshold distance may be changed depending on whether the mobile robot 20 moves in the low speed mode at a speed below the speed threshold value or in the high speed mode at a speed equal to or larger than the speed threshold value. It goes without saying that the threshold distance may be divided into three or more stages. For example, different threshold distances may be set upon setting three stages of high-speed mode, medium-speed mode, and low-speed mode. The higher the speed, the larger the threshold distance. That is, the threshold distance is the smallest in the lowest speed mode.

The traveling information 223 is information on traveling acquired by the traveling information acquisition unit 213, and is transmitted initiatively or upon request from the host management device 10 via the communication unit 23 periodically, every time the transport task is completed, or every time the passing point is passed. The host management device 10 updates the traveling information 127 based on the traveling information 223 received from the mobile robot 20.

Similar to the transported object information 126, the transported object information 226 includes information on the transported object. The transported object information 226 includes information such as the content (type) of the transported object, the transport source, and the transport destination. The transported object information 226 may include information indicating the status such as transport under way, pre-transport (before loading), and post-transport. These types of information in the transported object information 226 are associated with each transported object. The transported object information 226 only needs to include information on the transported object transported by the mobile robot 20. Therefore, the transported object information 226 is a part of the transported object information 126. That is, the transported object information 226 does not have to include the information on the transportation performed by other mobile robots 20.

The drive control unit 212 refers to the robot control parameter 222 and stops the operation or decelerates in response to the fact that the distance indicated by the distance information obtained from the distance sensor group 24 has fallen below the threshold distance. The drive control unit 212 controls the drive unit 26 such that the mobile robot 20 travels at a speed equal to or lower than the speed upper limit value. The drive control unit 212 limits the rotation speed of the drive wheels such that the mobile robot 20 does not move at a speed equal to or higher than the speed upper limit value.

Configuration Example of Mobile Robot 20

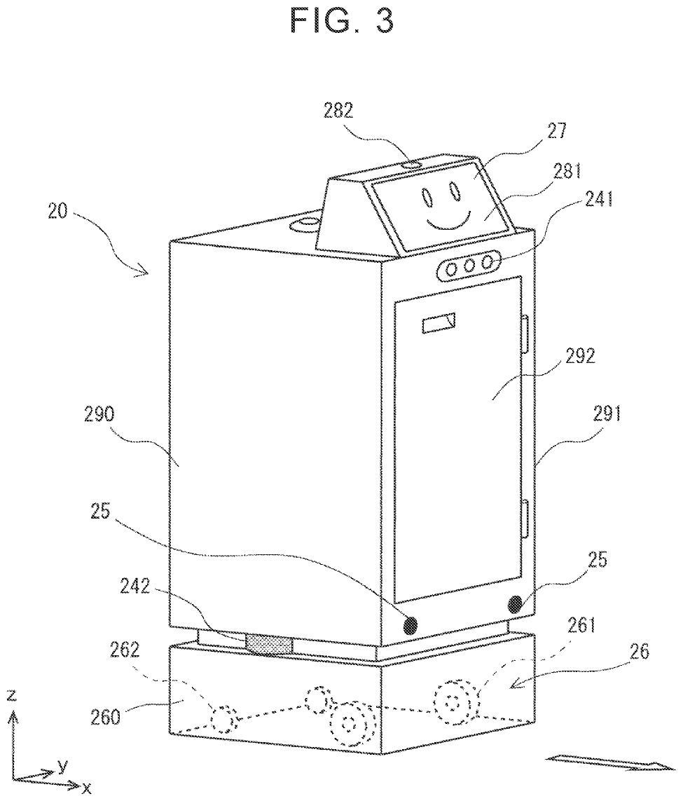

Here, the appearance of the mobile robot 20 will be described. FIG. 3 shows a schematic view of the mobile robot 20. The mobile robot 20 shown in FIG. 3 is one of the modes of the mobile robot 20, and may be in another form. In FIG. 3, the x direction is the forward and backward directions of the mobile robot 20, they direction is the right-left direction of the mobile robot 20, and the z direction is the height direction of the mobile robot 20.

The mobile robot 20 includes a main body portion 290 and a carriage portion 260. The main body portion 290 is installed on the carriage portion 260. The main body portion 290 and the carriage portion 260 each have a rectangular parallelepiped housing, and each component is installed inside the housing. For example, the drive unit 26 is housed inside the carriage portion 260.

The main body portion 290 is provided with the storage 291 that serves as a storage space and a door 292 that seals the storage 291. The storage 291 is provided with a plurality of shelves, and the availability is managed for each shelf. For example, by providing various sensors such as a weight sensor in each shelf, the availability can be updated. The mobile robot 20 moves autonomously to transport the transported object stored in the storage 291 to the destination instructed by the host management device 10. The main body portion 290 may include a control box or the like (not shown) in the housing. Further, the door 292 may be able to be locked with an electronic key or the like. Upon arriving at the transport destination, the user U2 unlocks the door 292 with the electronic key. Alternatively, the door 292 may be automatically unlocked when the mobile robot 20 arrives at the transport destination.

As shown in FIG. 3, front-rear distance sensors 241 and right-left distance sensors 242 are provided as the distance sensor group 24 on the exterior of the mobile robot 20. The mobile robot 20 measures the distance of the peripheral objects in the front-rear direction of the mobile robot 20 by the front-rear distance sensors 241. The mobile robot 20 measures the distance of the peripheral objects in the right-left direction of the mobile robot 20 by the right-left distance sensors 242.

For example, the front-rear distance sensor 241 is provided on the front surface and the rear surface of the housing of the main body portion 290. The right-left distance sensor 242 is provided on the left side surface and the right side surface of the housing of the main body portion 290. The front-rear distance sensors 241 and the right-left distance sensors 242 are, for example, ultrasonic distance sensors and laser rangefinders. The front-rear distance sensors 241 and the right-left distance sensors 242 detect the distance from the peripheral objects. When the distance from the peripheral object detected by the front-rear distance sensor 241 or the right-left distance sensor 242 becomes equal to or less than the threshold distance, the mobile robot 20 decelerates or stops.

The drive unit 26 is provided with drive wheels 261 and casters 262. The drive wheels 261 are wheels for moving the mobile robot 20 frontward, rearward, rightward, and leftward. The casters 262 are driven wheels that roll following the drive wheels 261 without being given a driving force. The drive unit 26 includes a drive motor (not shown) and drives the drive wheels 261.

For example, the drive unit 26 supports, in the housing, two drive wheels 261 and two casters 262, each of which are in contact with the traveling surface. The two drive wheels 261 are arranged such that their rotation axes coincide with each other. Each drive wheel 261 is independently rotationally driven by a motor (not shown). The drive wheels 261 rotate in accordance with a control command value from the drive control unit 212 in FIG. 2. The casters 262 are driven wheels that are provided such that a pivot axis extending in the vertical direction from the drive unit 26 pivotally supports the wheels at a position away from the rotation axis of the wheels, and thus follow the movement direction of the drive unit 26.

For example, when the two drive wheels 261 are rotated in the same direction at the same rotation speed, the mobile robot 20 travels straight, and when the two drive wheels 261 are rotated at the same rotation speed in the opposite directions, the mobile robot 20 pivots around the vertical axis extending through approximately the center of the two drive wheels 261. Further, by rotating the two drive wheels 261 in the same direction and at different rotation speeds, the mobile robot 20 can proceed while turning right and left. For example, by making the rotation speed of the left drive wheel 261 higher than the rotation speed of the right drive wheel 261, the mobile robot 20 can make a right turn. In contrast, by making the rotation speed of the right drive wheel 261 higher than the rotation speed of the left drive wheel 261, the mobile robot 20 can make a left turn. That is, the mobile robot 20 can travel straight, pivot, turn right and left, etc. in any direction by controlling the rotation direction and the rotation speed of each of the two drive wheels 261.

Further, in the mobile robot 20, the display unit 27 and an operation interface 281 are provided on the upper surface of the main body portion 290. The operation interface 281 is displayed on the display unit 27. When the user touches and operates the operation interface 281 displayed on the display unit 27, the operation reception unit 28 can receive an instruction input from the user. An emergency stop button 282 is provided on the upper surface of the display unit 27. The emergency stop button 282 and the operation interface 281 function as the operation reception unit 28.

The display unit 27 is, for example, a liquid crystal panel that displays a character's face as an illustration or presents information on the mobile robot 20 in text or with an icon. By displaying a character's face on the display unit 27, it is possible to give surrounding observers the impression that the display unit 27 is a pseudo face portion. It is also possible to use the display unit 27 or the like installed in the mobile robot 20 as the user terminal 400.

The cameras 25 are installed on the front surface of the main body portion 290. Here, the two cameras 25 function as stereo cameras. That is, the two cameras 25 having the same angle of view are provided so as to be horizontally separated from each other. An image captured by each camera 25 is output as image data. It is possible to calculate the distance from the subject and the size of the subject based on the image data of the two cameras 25. The arithmetic processing unit 21 can detect a person, an obstacle, or the like at positions forward in the movement direction by analyzing the images of the cameras 25. When there are people or obstacles at positions forward in the traveling direction, the mobile robot 20 moves along the route while avoiding the people or the obstacles. The image data of the cameras 25 is transmitted to the host management device 10.

The mobile robot 20 recognizes the peripheral objects and identifies the position of the mobile robot 20 itself by analyzing the image data output by the cameras 25 and the detection signals output by the front-rear distance sensors 241 and the right-left distance sensors 242. The cameras 25 capture images of the front of the mobile robot 20 in the traveling direction. As shown in FIG. 3, the mobile robot 20 considers the side on which the cameras 25 are installed as the front of the mobile robot 20. That is, during normal movement, the traveling direction is the forward direction of the mobile robot 20 as shown by the arrow.

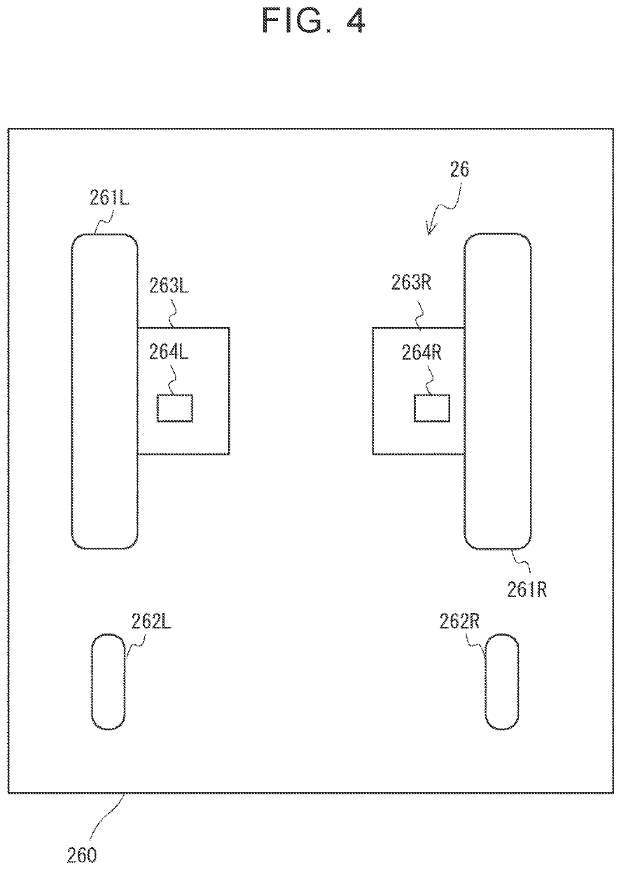

Next, the main configuration of the drive unit 26 will be described with reference to FIG. 4. FIG. 4 is a diagram schematically showing a main configuration example of the drive unit 26. Here, for distinguishing the right and left drive wheels 261 shown in FIG. 3, the left drive wheel 261 is referred to as a drive wheel 261L, the right drive wheel 261 is referred to as a drive wheel 261R. Similarly, for the casters 262, the left caster 262 is referred to as a caster 262L and the right caster 262 is referred to as a caster 262R. The drive unit 26 includes the drive wheels 261L, 261R, motors 263L, 263R, and wheel sensors 264L, 264R.

The motor 263L is a drive mechanism that drives the drive wheel 261L. The motor 263R is a drive mechanism that drives the drive wheel 261R. For example, the motors 263L and 263R are controlled to move along the movement route to the destination. Specifically, the motors 263L and 263R are rotationally driven according to the control command value from the drive control unit 212.

The wheel sensor 264L detects the operation of the drive wheel 261L. The wheel sensor 264R detects the operation of the drive wheel 261R. The wheel sensor 264L and the wheel sensor 264R are encoders each provided on the motor 263L and the motor 263R. For example, the wheel sensor 264L detects the rotation angle of the drive wheel 261L. The wheel sensor 264R detects the rotation angle of the drive wheel 261R. The current position of the mobile robot 20 in the floor map 221 may be obtained by integrating the rotation speeds from the wheel sensor 264L and the wheel sensor 264R.

Further, the wheel sensors 264L and 264R output the detection results to the traveling information acquisition unit 213 in FIG. 2. As a result, the traveling information acquisition unit 213 can obtain a part of the information necessary for the traveling information 223. The larger the integrated value of the number of rotations, the larger the tire wear (wear) of the drive wheels 261, which indicates larger load. The longer the drive time, the larger the load and the longer the traveling distance, the larger the load. When the manager or the like performs maintenance and replaces the drive wheels 261L and 261R with new ones, the traveling information acquisition unit 213 preferably resets the information on the load of the replaced drive wheels to the initial value (for example, zero), or preferably stores the traveling information 223 so that the maintenance date and time can be recognized.

Example of Task Assignment

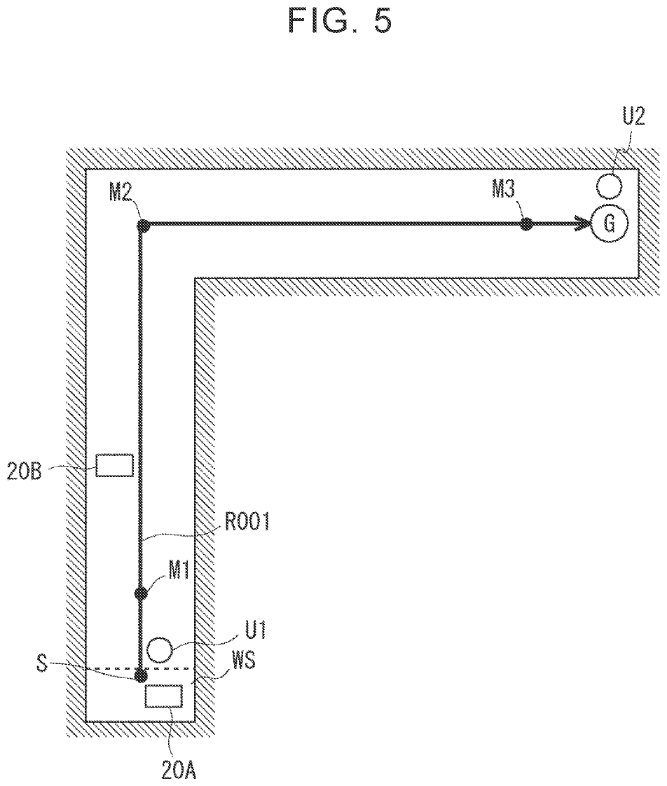

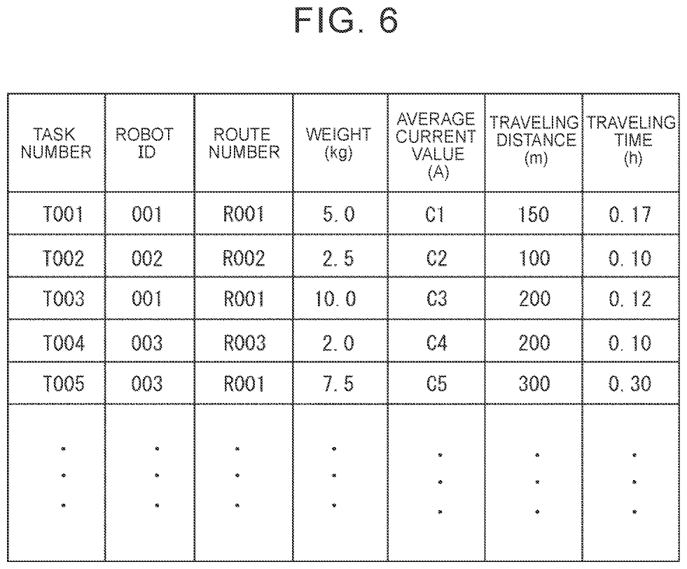

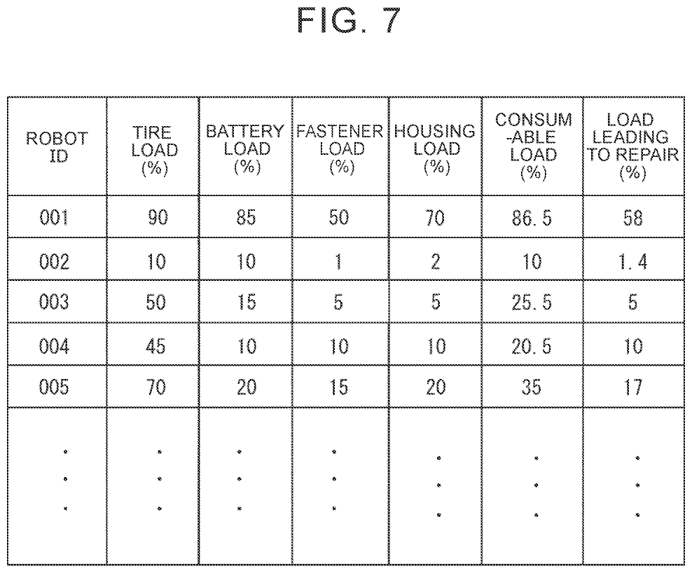

An example of determination processing of the mobile robot 20 to be used, that is, an example of task assignment to the mobile robot 20, will be described with reference to FIGS. 5 to 8. FIG. 5 is a diagram showing an example of a movement route of the mobile robot 20. FIG. 6 is a diagram showing an example of a table in which a current value, a traveling distance, and a traveling time for each mobile robot 20 are stored. FIG. 7 is a diagram showing an example of a load estimation result for each mobile robot 20.

FIG. 5 shows an example in which the user U1 makes a transport request so as to transport the transported object from the transport source S to the transport destination G. As an example, the user U1 is in the vicinity of the transport source S, the user U2 is in the vicinity of the transport destination G, and the position of the mobile robot 20A is substantially the same as that of the transport source S. In FIG. 5, it is assumed that the mobile robot 20A waiting in the standby space WS and a mobile robot 20B moving at another position or waiting at another position can load the transported object to be transported.

Passing points M1 to M3 are set in the movement route (traveling route) R001 from the transport source S to the transport destination G planned by the route planning unit 115, and the mobile robot 20A and the mobile robot 20B are selected as candidates. In the movement route R001, the mobile robot 20A or the mobile robot 20B passes in the order of the passing points M1, M2, and M3. Here, the movement route R001 from the transport source S to the transport destination G is not changed when the mobile robot 20A is assigned as the use target (execution target). However, when the mobile robot 20B is assigned as the use target, a route from the current position of the mobile robot 20B to the transport source S will be added.

Therefore, in this transport task for moving along the movement route R001, the movement distance and the traveling time are shorter when the mobile robot 20A is assigned than when the mobile robot 20B is assigned. However, in the present embodiment, the assignment is determined not only by the above. An example of such a determination will be described below.

First, for the mobile robots 20A and 20B, the load estimation unit 117 executes an estimation process for estimating the load applied to each of the mobile robots 20A and 20B based on each current value during traveling and the traveling distance or the traveling time with reference to the traveling information 127. The load estimation unit 117 records the result of the estimation process as the load information 128, or updates the load information 128 with the result of the estimation process.

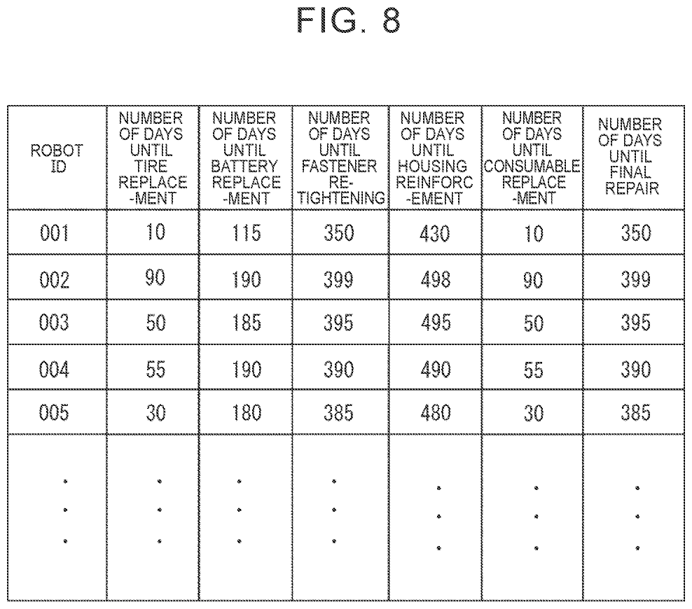

The table shown in FIG. 6 shows an example of the information recorded as the traveling information 127, and the case where the traveling information 127 is represented by such values will be described as an example. However, the values exemplified in FIG. 6 and FIGS. 7 and 8 described later are merely examples for roughly and qualitatively describing the estimation example here. In the table of FIG. 6, information on the robot ID, the route number, the weight of the transported object, the average current value, the traveling distance, and the traveling time is included for each task number. It should be noted that one instantaneous value can be used instead of the average current value, and even when the average current value is used, the value can be the average of a plurality of instantaneous values obtained as samples. It goes without saying that the format of the traveling information 127 and the formats of FIGS. 7 and 8 described later are not limited to these, and other formats may be used. It is assumed that C1 to C5 contain actual values. Here, the robot ID of the mobile robot 20A will be described as 001, and the robot ID of the mobile robot 20B will be described as 002.

With reference to the table of FIG. 6, the load estimation unit 117 estimates the load for each robot ID. The load can be estimated based on the weight of the loaded object, the traveling distance or the traveling time, and the route indicated by the route number.

For example, the load applied to the tires (degree of tire wear) can be estimated by using the product of the traveling distance or the traveling time and the weight of the loaded object. Further, for example, the load applied to the battery can be estimated by using the product of the current value and the traveling distance or the traveling time. Also, for example, the estimation of the load applied to the tires can be executed by merging the traveling distance with traveling history information within the facility (for example, the traveling route of the transport task, the number of times the mobile robot has passed an elevator, the condition of the floor, the number of times the mobile robot has passed a step, etc.). As in the above example, merging here can include weighting each parameter and obtaining the sum, or obtaining a product with another parameter to correct the parameter of the traveling amount (traveling time or traveling distance). The factors that determine the load amount of the mobile robot 20 are complex, and various parameters can be used for estimation, such as the battery, the traveling distance, the number of times the battery is charged, the weight of the loaded object, the number of transport times, and the number of times the mobile robot gets on and off the elevator. In fact, when the mobile robot gets on and off the elevator, the movement to get over the step occurs, so that the wear is promoted. Also, cases including steps exist in other situations, such as Braille blocks and boundaries according to road conditions (e.g. boundaries between carpets and floor surfaces without carpets). In cases outside the facility, since there are many rough outside road surfaces, wear is promoted as well.

Based on such estimation, for example, according to the values shown in the table of FIG. 6, it is estimated that the mobile robot 20A having the robot ID of 001 has a larger load than the mobile robot 20B having the robot ID of 002.

Specifically, for example, as shown in the table shown in FIG. 7, the load is estimated and recorded or updated as the load information 128. In FIG. 7, for simplifying the description, the ratios are indicated assuming that the load of the threshold value requiring maintenance is 100%, but the indication method and unit of the load are not limited to this.

In the table shown in FIG. 7, the loads are represented by type, such as the tire load, the battery load, the fastener load, and the housing load. Alternatively, only one type of load may be estimated. The consumable load is a consumable load calculated from the tire load and the battery load, and is exemplified here by a value of (tire load)×0.3+(battery load)×0.7. Both the tire load and the battery load can be estimated as integrated values from the time of replacement during maintenance, based on each value of the weight of the transported object, the current value, the traveling distance, and the traveling time. As described above, the consumable load can be, for example, a value obtained by comprehensively evaluating the tire load and the battery load.

The fastener load indicates a load applied to the fastener for fixing the door or the housing of the mobile robot 20, and a larger fastener load means that the fastener may loosen or come off. The housing load indicates a load applied to the housing of the mobile robot 20, and a larger housing load means that the housing may be broken. Both the fastener load and the housing load can be estimated as integrated values from the time of replacement or repair during maintenance, based on each value of the weight of the transported object, the current value, the traveling distance, and the traveling time. The fastener load can also be estimated based on at least one of the above values and the value of the accelerometer mounted on the mobile robot 20. The load leading to repair is the load that is calculated from the fastener load and the housing load and that results in repair due to defects in the fastener or the housing that may cause the transported object to fall or be stolen. The load leading to repair is exemplified by the value of (fastener load)×0.6+(housing load)×0.4. As described above, the load leading to repair can be, for example, a value obtained by comprehensively evaluating the fastener load and the housing load.

Also, by referring to the route number, for example, it is possible to distinguish between a route with a lot of clockwise rotation and a route with a lot of counterclockwise rotation to consider the difference in the degree of wear of the right and left tires, and it is also possible to estimate the load in consideration of the amount of uphill slopes and downhill slopes. In addition, by referring to the route number, it is possible to estimate the load in consideration of steps, elevators, floor materials such as Braille blocks, etc. included in the traveling route. For example, it is possible to estimate a larger load applied to the fastener when there are many steps compared to when there are few steps. Although only four types of loads are shown as examples, depending on the route, when there are many uphill slopes, a large load will be applied to the battery and the drive unit 26, and when there are many downhill slopes, a large load will be applied to brake-related parts.

The robot assignment unit 118 refers to the load information 128 and determines the mobile robot 20 to be used from the mobile robots 20A and 20B. For example, when the load information 128 is the information shown in the table of FIG. 7, the mobile robot 20A (robot ID: 001) has a larger load than the mobile robot 20B (robot ID: 002), so that the robot assignment unit 118 determines the mobile robot 20B as the mobile robot 20 to be used to preferentially use the mobile robot 20B.

Here, the robot assignment unit 118 may determine the mobile robot 20 to be used in consideration of the balance of each load, and may determine the mobile robot 20 to be used based on at least one of the consumable load and the load leading to repair. Further, it is possible to determine the mobile robot 20 to be used based on the individual load without calculating the consumable load and the load leading to repair as a comprehensive evaluation. For example, the mobile robot 20 to be used may be determined in consideration of only the tire load, only the battery load, only the load of the item with the highest value [the battery load in this example], only the tire load and the battery load, only the fastener load, only the housing load, or the like.

As described above, the system 1 according to the present embodiment determines the mobile robot 20 to be used from the result of estimating the load for each mobile robot 20 based on the current value and the traveling time or the traveling distance, etc. Both the traveling distance and the traveling time can be used for estimation.

Therefore, in the system 1, when operating a plurality of mobile robots 20, it is possible to perform operations according to the degree of wear of the mobile robots 20. For example, in fact, if only the same mobile robot 20 is used, the frequency of repairing the parts constituting the mobile robot 20 increases. However, in the system 1, even when the mobile robot 20 closest to the calling point is a candidate to be called, when the degree of wear is high, another mobile robot 20 having a low degree of wear can be called and used. Therefore, it is possible to equalize the degree of wear indicated by values such as the value obtained by multiplying the traveling distance or the traveling time with the current value (and the weight of the loaded object) between the mobile robots 20 to assign the mobile robots 20. Alternatively, the degree of wear can be increased or decreased as compared with other mobile robots 20 in order to adjust the maintenance date. This has the effect of facilitating maintenance scheduling.

Here, the case where the mobile robot 20 has tires has been described. The tires are generally provided around the wheels. In this case, as described above, the load estimation unit 117 may estimate the degree of tire wear by using the product of the above current value and the traveling distance or the traveling time as the estimated load or a part thereof. This makes it possible to perform operations according to the degree of tire wear of the mobile robot 20, which is an example of the degree of wear of the mobile robot 20.

Further, as shown in the table of FIG. 6, the load estimation unit 117 may execute the estimation process by using the weight information indicating the weight of the loaded object that is loaded on the mobile robot 20. This allows the load to be estimated to correspond to the weight of the loaded object.

Further, as shown in the table of FIG. 6, the load estimation unit 117 may execute the estimation process by using the route information indicating the route traveled by the mobile robot 20. This allows the load to be estimated to correspond to the traveling route.

Further, the robot assignment unit 118 may determine the mobile robot 20 to be used so that the estimated load amount is not biased among the plurality of mobile robots 20. This means that the robot assignment unit 118 may determine the mobile robot 20 to be used so that the timing at which the estimated load exceeds a predetermined threshold value (the timing when the load becomes excessive), in other words, the timing of the degree of wear of the mobile robot 20 predetermined according to the load, is not biased. As a result, the plurality of mobile robots 20 can be operated so that the degree of wear is aligned.

Further, the robot assignment unit 118 may determine the mobile robot 20 to be used so that the timing when the estimated load amount exceeds a predetermined threshold value meets a predetermined schedule. This schedule can be determined with reference to the work schedule in the facility management system 30. By determining the mobile robot 20 to be used so that the consumption timing of the plurality of mobile robots 20 is adjusted to a predetermined schedule in this way, operation can be performed so that maintenance of the plurality of mobile robots 20 or some of the plurality of mobile robots can be performed at the same period.

Further, regarding the timing at which the load amount exceeds a predetermined threshold value, the load may be a plurality of types of loads as exemplified above, and in that case, a predetermined threshold value is set for each load. For example, the timing at which the load amount exceeds a predetermined threshold value may the timing when one load exceeds the threshold value, or may be the timing when a predetermined number of loads exceeds the respective predetermined threshold values.

Here, the predetermined schedule can be a schedule predetermined as a maintenance schedule, or may be a schedule selected by the facility management system 30 as a period when there is a small amount of work (a period avoiding the busy season). In other words, the predetermined schedule may be set at a period when there is a small amount of work in the facility where the plurality of mobile robots 20 perform transportation. As a result, it is possible to perform the operation so that the maintenance of the plurality of mobile robots 20 can be performed collectively at a period when there is a small amount of work. Especially in hospitals, it is expected that the mobile robots 20 will be used frequently when performing surgery, so the above-mentioned predetermined schedule should be determined as the period when there are few tasks based on the information on the tasks (mainly surgery) in the hospital. The facility management system 30 may be excluded in the system 1 when the robot to be used is not determined in consideration of the schedule for such work.

Further, as described as an example of selecting candidates in advance by the route planning unit 115, in addition to the load estimation result, the host management device 10 may determine candidates based on the scheduled route information indicating the route that is scheduled to be used for transportation and the scheduled transported object information indicating the transported object that is scheduled to be transported. As a result, not only efficient transportation can be performed in terms of time and total traveling distance, but also determinations can be made according to the traveling distance or the traveling time in the route, the degree of load applied, and the like, making it easier to adjust the load between the plurality of mobile robots 20.

In this way, the robot assignment unit 118 may determine the mobile robot 20 to execute the transport task by using not only the load of each mobile robot 20 but also information other than the load.

Further, the load estimation unit 117 not only estimates the load but can also estimate the maintenance timing as follows. Such an example will be described with reference to FIG. 8. FIG. 8 is a diagram showing an example of an estimation result of the maintenance timing for each mobile robot.

The load estimation unit 117 may further include a process of estimating the maintenance timing of the mobile robot 20 for the plurality of mobile robots 20 as the estimation process. This estimation can also be performed based on the current value and the traveling distance or the traveling time of the mobile robot 20. For example, the estimation of the replacement period of the tires can be executed by merging the traveling distance with the traveling history information within the facility (for example, the traveling route of the transport task, the number of times the mobile robot has passed an elevator, the condition of the floor, the number of times the mobile robot has passed a step, etc.). As in the above example, merging here can include weighting each parameter and obtaining the sum, or obtaining a product with another parameter to correct the parameter of the traveling amount (traveling time or traveling distance). The factors that determine the maintenance period of the mobile robot 20 are complex, and various parameters can be used for estimation, such as the battery, the traveling distance, the number of times the battery is charged, the weight of the loaded object, the number of transport times, and the number of times the mobile robot gets on and off the elevator.

Specifically, for example, as shown in the table shown in FIG. 8, the maintenance period is estimated and recorded or updated as a part of the load information 128. In FIG. 8, for simplifying the description, the number of working days remaining until the maintenance date according to the load of the threshold value requiring maintenance is described for each load, but the indication method and unit of the load are not limited to this.

In the table shown in FIG. 8, maintenance dates corresponding to loads are represented by type, such as the tire replacement date, the battery replacement date, the fastener re-tightening date, and the housing reinforcement date. Alternatively, only the maintenance date corresponding to one type of load may be estimated. The consumables replacement date is obtained as the shorter one of the tire replacement date and the battery replacement date, and the final repair date is obtained as the shorter one of the fastener re-tightening date and the housing reinforcement date, but the configuration is not limited to this.

The estimation result of such timings can also be used as determination materials for determining the mobile robot 20 to be used in the robot assignment unit 118. As a result, the mobile robot 20 to be used can be determined according to the maintenance timing of the mobile robot 20, and the operation can be performed according to the need for maintenance of the mobile robot 20.

In fact, compared to the case where maintenance for all the mobile robots 20 are performed at the same time at regular timings regardless of the traveling amount, maintenance can be performed while avoiding the busy season, for example.

Robot Management Method

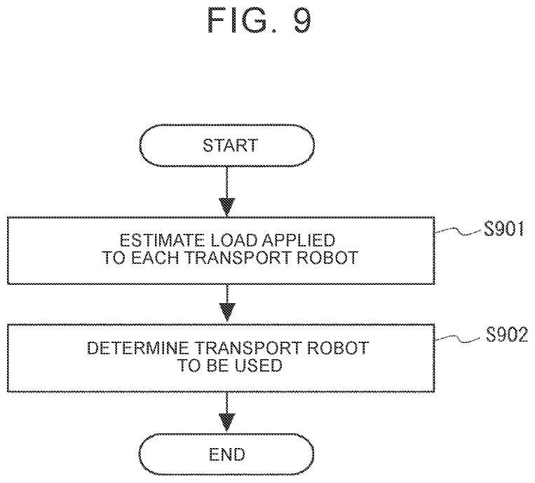

An example of the robot management method (robot assignment process) in the system 1 described above will be described with reference to FIG. 9. FIG. 9 is a flowchart showing an example of a robot management method according to the present embodiment.

As shown in FIG. 9, first, for a plurality of transport robots (mobile robots 20) that are the management targets or that have been selected as candidates for executing a transport task, the host management device 10 executes an estimation process for estimating the load applied to the mobile robots 20 based on the current value during traveling and the traveling distance or the traveling time of the mobile robots 20 (S901).

Next, the host management device 10 determines the mobile robot 20 to be used in the target (new) transport task based on the estimated load for each mobile robot 20 (S902), and ends the process. After that, the target transport task is executed by the mobile robot 20 to be used.

Other Robot Management Method

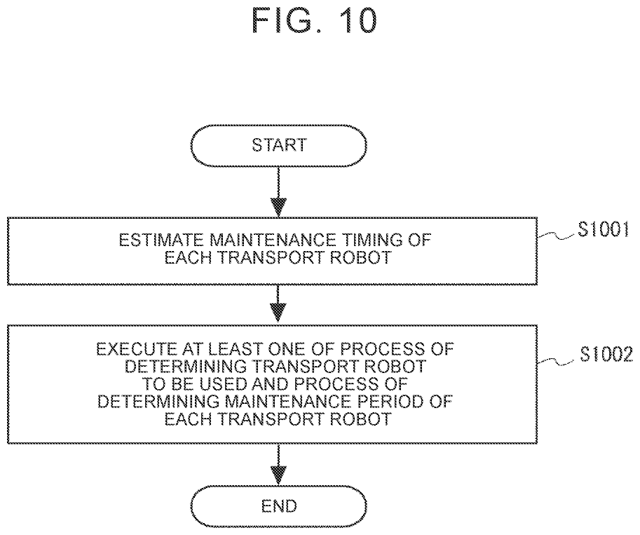

As an example of the robot management method in the system 1 described above, an example of processing related to the maintenance period will be described with reference to FIG. 10. FIG. 10 is a flowchart showing another example of a robot management method according to the present embodiment.

As shown in FIG. 10, first, for a plurality of transport robots (mobile robots 20) that are the management targets or that have been selected as candidates for executing a transport task, the host management device 10 estimates the maintenance timing of the mobile robots 20 based on the current value during traveling and the traveling distance or the traveling time of the mobile robots 20 (S1001).

Next, the host management device 10 determines the mobile robot 20 to be used in the target (new) transport task based on the estimated maintenance timing for each mobile robot 20 (S1002), and ends the process. After that, the target transport task is executed by the mobile robot 20 to be used.

In S1002, instead of or in addition to such a determination, the host management device 10 can also determine the maintenance period of each mobile robot 20 based on the estimated maintenance timing of each mobile robot 20. After that, maintenance will be performed for each mobile robot 20 according to this maintenance period. At that time, the host management device 10 can also register, for example, maintenance information indicating a location requiring maintenance, necessary parts, and the like for each mobile robot 20 as work in the facility management system 30. As a result, the manager can refer to the above to perform maintenance and instruct operators to perform maintenance.

Thereby, even when the estimated maintenance timing is slightly different, it is possible to determine to align the maintenance period for the plurality of mobile robots 20. In this way, the estimation of the maintenance timing can be executed independently of the determination process of the mobile robot 20 to be used. In that case, for example, the host management device 10 may be constructed as follows. That is, for example, the host management device 10 may include a timing estimation unit that estimates the maintenance timing instead of the load estimation unit 117, and may cause the storage unit 12 to store timing information indicating the timing instead of the load information 128. Further, the host management device 10 may exclude the robot assignment unit 118 so that the route planning unit 115 determines the mobile robot 20 to execute the transport task.

Others

A part or all of the processing in the host management device 10, the mobile robot 20, the user terminal 400, the facility management system 30, and the like described above can be realized as a computer program. The program described above includes a set of instructions (or software code) for causing the computer to perform one or more of the functions described in the embodiments when loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or other memory technologies, a compact disc read-only memory (CD-ROM), a digital versatile disc (DVD), a Blu-ray (registered trademark) disc or other optical disc storages, a magnetic cassette, a magnetic tape, a magnetic disc storage, or other magnetic storage devices. The program may be transmitted on a transitory computer-readable medium or a communication medium. Examples of the transitory computer-readable medium or the communication medium include, but is not limited to, an electrical, optical, acoustic, or other form of propagating signal.

Note that the present disclosure is not limited to the above embodiment, and can be appropriately modified without departing from the spirit.

What is claimed is:

1. A robot management system that executes, for a plurality of transport robots, an estimation process for estimating load applied to the transport robots based on a current value during traveling and a traveling distance or a traveling time of the transport robots, and that determines a transport robot to be used from among the transport robots based on an estimation result in the estimation process.

2. The robot management system according to claim 1, wherein:
the transport robots include tires; and
the estimation process includes estimating a degree of wear of the tires by using a product of the current value and the traveling distance or the traveling time as the load or a part of the load.

3. The robot management system according to claim 1, wherein the transport robot to be used is determined such that an amount of the load is not biased among the transport robots.

4. The robot management system according to claim 1, wherein the transport robot to be used is determined such that a timing at which the amount of the load exceeds a predetermined threshold value meets a predetermined schedule.

5. The robot management system according to claim 4, wherein the predetermined schedule is set at a period when there is a small amount of work in a facility where the transport robots perform transportation.

6. The robot management system according to claim 1, wherein the estimation process is executed using weight information indicating a weight of a loaded object that is loaded on the transport robots.

7. The robot management system according to claim 1, wherein the estimation process is executed by using route information indicating a route traveled by the transport robots.

8. The robot management system according to claim 1, wherein the transport robot to be used is determined based on at least one of scheduled route information indicating the route that is scheduled to be used for transportation and scheduled transported object information indicating a transported object that is scheduled to be transported.

9. The robot management system according to claim 1, wherein the estimation process further includes a process of estimating, for the transport robots, a maintenance timing of the transport robots.

10. A robot management method for executing, for a plurality of transport robots, an estimation process for estimating load applied to the transport robots based on a current value during traveling and a traveling distance or a traveling time of the transport robots, and determining a transport robot to be used from among the transport robots based on an estimation result in the estimation process.

11. The robot management method according to claim 10, wherein:
the transport robots include tires; and
the estimation process includes estimating a degree of wear of the tires by using a product of the current value and the traveling distance or the traveling time as the load or a part of the load.

12. The robot management method according to claim 10, wherein the transport robot to be used is determined such that an amount of the load is not biased among the transport robots.

13. The robot management method according to claim 10, wherein the transport robot to be used is determined such that a timing at which the amount of the load exceeds a predetermined threshold value meets a predetermined schedule.

14. The robot management method according to claim 13, wherein the predetermined schedule is set at a period when there is a small amount of work in a facility where the transport robots perform transportation.

15. The robot management method according to claim 10, wherein the estimation process is executed using weight information indicating a weight of a loaded object that is loaded on the transport robots.

16. The robot management method according to claim 10, wherein the estimation process is executed by using route information indicating a route traveled by the transport robots.

17. The robot management method according to claim 10, wherein the transport robot to be used is determined based on at least one of scheduled route information indicating the route that is scheduled to be used for transportation and scheduled transported object information indicating a transported object that is scheduled to be transported.

18. The robot management method according to claim 10, wherein the estimation process further includes a process of estimating, for the transport robots, a maintenance timing of the transport robots.

19. A program causing a computer to execute processes comprising executing, for a plurality of transport robots, an estimation process for estimating load applied to the transport robots based on a current value during traveling and a traveling distance or a traveling time of the transport robots, and determining a transport robot to be used from among the transport robots based on an estimation result in the estimation process.

20. The program according to claim 19, wherein:
the transport robots include tires; and
the estimation process includes estimating a degree of wear of the tires by using a product of the current value and the traveling distance or the traveling time as the load or a part of the load.
